(19) United States
(12) Patent Application Publication
(10) Pub. No.: US 2005/0056806 A1
(43) Pub. Date: Mar. 17, 2005

(54) Suppressing monovalent metal ion migration using aluminum-containing barrier layer

(76) Inventors: Adam J. G. Ellison, Painted Post, NY (US); Heather D. Boek, Corning, NY (US)

Correspondence Address: CORNING INCORPORATED, SP-TI-3-1, CORNING, NY, 14831, US

(21) Appl. No.: 10/936,054

(22) Filed: Sep. 7, 2004

Related U.S. Application Data
(60) Provisional application No. 60/500,635, filed on Sep. 5, 2003.

(51) Int. Cl. C03C 3/06

(52) U.S. Cl. 252/62.3 R; 427/446; 65/17.2; 65/17.4

(57) ABSTRACT

Disclosed is a process for suppressing monovalent metal ion migration between inorganic materials by placing a barrier layer containing Al₂O₃ and SiO₂ between the inorganic materials. Also disclosed is a process for making silica-containing body comprising a step of forming a barrier layer containing Al₂O₃ and SiO₂ over the soot-receiving substrate before the laydown of the fused silica boule. The barrier layer is effective in suppressing monovalent metal ion, especially alkali metal ion, particularly sodium migration at elevated temperature. The processes are particularly useful in the production and working of HPFS® materials required of a very low alkali metal, especially sodium, concentration.

### CROSS-REFEENCE TO RELATED APPLICATIONS

The present application claims priority of U.S. Provisional Patent Application Ser. No. 60/500,635, filed on Sep. 5, 2003, entitled “Alumina Barrier to Suppress Na Migration in HPFS,” the content of which is relied upon and incorporated herein by reference in its entirety.

### FIELD OF THE INVENTION

The present invention relates to materials and processes for suppressing monovalent metal ion migration between otherwise abutting inorganic materials. In particular, the present invention relates to aluminum-containing material and process for suppressing monovalent metal ion migration from one inorganic material having higher monovalent metal ion concentration to another inorganic material having lower monovalent metal ion concentration at elevated temperatures during the processing or production of the low-monovalent metal ion material. The present invention is useful, for example, in the production of low Na high purity fused silica material, doped or undoped.

### BACKGROUND OF THE INVENTION

Many inorganic materials, such as high purity fused silica (HPFS®), doped fused silica such as aluminum doped fused silica, fluorine doped fused silica, titanium doped fused silica, CaF₂, MgF₂, and the like, find use in many modern technologies, for example, in optical applications. In many of these applications, these materials are required to have extremely low level of metal contaminants. It is known that in the UV region, particularly in the deep UV and vacuum UV region significant for the microlithography technology, contamination by monovalent metal ions, especially alkaline metal ions, particularly sodium ion, causes undesirable transmission loss and fluorescence in optical materials such as HPFS®. The exact cause is not well-understood, but appears to be due to the formation of non-bridging (for example, Si—O—Na) bonds in the glass. The fused silica glass material used in the microlithography market currently requires ArF laser (193 nm) internal transmission exceeding 99.65%/cm, and preferably exceeding 99.75%/cm. Reduction of metal contaminants, which have a major impact on UV transmission, plays a major role in the production of high transmission fused silica. The effects of metals, such as sodium, potassium and iron, are evident at the 10's of parts per billion level. Therefore, it is imperative to keep sodium and other monovalent metal ion contamination levels as low as possible during the processing and production of the materials to maintain high transmission of the glass material.

Titanium doped fused silica material, such as Corning glass code 7990, has found use in applications such as reflective mirror blanks due to its extremely low coefficient of thermal expansion. It is important to control the metal ion, especially monovalent metal ion, particularly sodium ion, contaminants level in this material as well because such contamination leads to CTE excursion and reduced CTE homogeneity.

In the technical field, an important process for making fused silica materials, doped or undoped, involves vapor phase hydrolysis and oxidation of precursor materials in a combustion flame. This process is typically called flame hydrolysis. Large high purity fused silica glass, doped or undoped, is typically made by depositing fine particles of silica in a refractory furnace at temperatures exceeding 1650° C. The silica particles are typically generated in a flame when a silicon containing raw material along with natural gas is passed through a fused silica producing burner into the furnace chamber. These particles are deposited and consolidated onto a rotating body. The rotating body is in the form of a refractory cup or containment vessel, which is used to provide insulation to the glass as it builds up, and the furnace cavity formed by the cup interior and the crown of the furnace is kept at high temperatures. The body formed by the deposited particles is often referred to as a “boule” and it is understood that this terminology includes any silica-containing body formed by a flame hydrolysis process.

A typical furnace for producing fused silica glass includes an outer ring wall, which supports a refractory crown. The crown is provided with a plurality of burner holes, and each such burner hole is provided with a burner positioned there above at an inlet end for directing a flame through the burner hole into the cavity of the furnace. The furnace is provided with a rotatable base, which with the containment wall forms a cup or containment vessel. The rotatable base, forming the bottom of the cup-like containment vessel, is covered with high purity bait sand which collects the initial silica particles forming the boule.

The refractory crown, having the burners positioned thereon, functions to trap heat within the furnace. However, since the flame and soot from the burners pass through the burner holes in the refractory crown, the burner holes are maintained at elevated temperature. Such elevated temperatures in the vicinity of each burner hole cause impurities to leach out of the refractory and produce undesirable dissolution of the refractory which contaminates the silica glass.

Various methods have been disclosed in the prior art in order to reduce the metal, especially sodium contamination of the fused silica material during the production in the furnace. Since the source of the metal contaminants are largely from the furnace walls, the cup and the bait sand, those methods are mostly focused on improvement on the furnace design and reduction of the level of metal contaminants in the furnace bricks and bait sands.

For example, U.S. Pat. No. 6,497,118 discloses a furnace in which the temperature of the refractory at the burner holes is reduced. The lowered burner hole refractory temperature reduces contaminants leached out from the refractory and leads to less undesirable dissociation of the refractory, thus reduces contamination of the fused silica material produced. U.S. Pat. Nos. 5,332,702 and 5,395,413 describe remedial measure taken to reduce the sodium content in the fused silica glass. Essentially, these measures comprise providing a purer zircon refractory for use in constructing a furnace in which the fused was deposited to form a boule. In particular, it was found necessary to use dispersants, binders and water relatively free of sodium ions in producing zircon refractory components for the furnace. U.S. Pat. No. 6,174,509 discloses a method of treating the refractory of the furnace with halogen-containing gas to reduce the contamination level.

However, further improvement to the production of fused silica and other inorganic materials is needed in order to reduce the level of metal contamination, especially sodium contamination of HPFS® at elevated temperatures.

In the processing and handling of inorganic materials at elevated temperature, such as sagging of fused silica material at a temperature over 1650° C., it is important that metal contaminants, especially monovalent metals, particularly sodium, do not migrated from the surface of the support material to the fused silica. Therefore, there exists the need of suppressing monovalent metal ion migration from the support to the fused silica material.

The present invention satisfies these needs.

### SUMMARY OF THE INVENTION

According to one aspect of the present invention, it is provided a process for suppressing monovalent metal ion migration from a first inorganic material to a second inorganic material at an elevated temperature, comprising forming a barrier layer sandwiched between the surfaces of the first inorganic material and the second inorganic material, said barrier layer comprising alumina and silica.

In one embodiment of the process of the present invention for suppressing monovalent metal ion migration, the monovalent metal ion is selected from alkaline metal ions, Ag⁺, and Cu⁺ and combinations thereof. Preferably the monovalent metal ion is sodium ion. Preferably, the barrier layer has a sodium diffusion coefficient at 1000° C. less than 10⁻⁸ cm²/s, more preferably less than 10⁻¹⁰ cm²/s.

In one embodiment of this process for suppressing monovalent metal ion migration of the present invention, the material of the barrier layer is formed by flame hydrolysis process. The material of the barrier layer may comprise, for example, up to 8% by weight of Al₂O₃. In one embodiment, the barrier layer may be a SiO₂—Al₂O₃ layer deposited directly on the surface of the first inorganic material by using a flame hydrolysis process at an elevated temperature. Preferably, the barrier layer is a continuous vitreous Al₂O₃—SiO₂ layer on top of the surface of the first inorganic material.

Alternatively, the barrier layer is a layer of ground particles of Al₂O₃—SiO₂ glass preformed by using flame hydrolysis processes, for example, the typical VAD or OVD process for producing waveguide fused silica material, or the typical direct-method for making large fused silica boules. The Al₂O₃—SiO₂ glass may be consolidated or unconsolidated. The silica precursor material in the flame hydrolysis process for making the barrier layer material may be, for example, silicon halides or organosilicon compounds typically used in flame hydrolysis processes. The alumina precursor material in the flame process for making the barrier layer material may be aluminum halides and typical organoaluminum materials used in flame hydrolysis processes.

Alternatively, the barrier layer may be formed from a layer of bulk glass or ground glass particles of melted aluminosilicate glass essentially free of monovalent metal ion. Preferably, the glass is a CaO—Al₂O₃—SiO₂ or La₂O₃—Al₂O₃—SiO₂ glass. Preferably, glass has a high molar Al₂O₃ percentage of at least 10%, more preferably at least 20%, still more preferably at least 30%. Preferably the glass has an Al₂O₃ molar percentage between 20-40%. Advantageously, the glass itself has a very low monovalent metal ion content of less than 800 ppb, preferably less than 500 ppb, more preferably less than 200 ppb, still more preferably less than 100 ppb, still more preferably less than 50 ppb, most preferably less than 20 ppb. Advantageously, the glass itself has a very low Na content of less than 300 ppb, preferably less than 200 ppb, more preferably less than 100 ppb, still more preferably less than 50 ppb, most preferably less than 20 ppb.

Alternatively, the barrier layer is formed by depositing a sol-gel layer comprising silica and alumina. The sol-gel preferably is formed from an aqueous slurry formed by at least one hydrolysable silicon compound and at least one hydrolysable aluminum compound in an acidic aqueous medium. Preferably, the at least one hydrolysable silicon compound has the following general formula
Rₘ—Si—Xₙ (I),
where R independently is a non-hydrolysable group, X independently is a hydrolysable group, m is an integer from 0 to 3, inclusive, n is an integer from 1 to 4, inclusive, and m+n=4;
the at least one hydrolysable aluminum compound is a compound having the following general formula
Sₒ—Al—Yₚ (II),
where S independently is a non-hydrolysable group, Y independently is a hydrolysable group, o is an integer from 0 to 2, inclusive, p is an integer from 1 to 3, inclusive, and o+p=3. Preferably, R and S independently are selected from the group consisting of optionally fluorinated C₁-C₂₄ alkyl and optionally fluorinated phenyl, X and Y are selected from the group consisting of hydrogen, halogen and OR′ where R′ is a C₁-C₄ alkyl.

According to another aspect of the present invention, it is provided a process for forming silica-containing body, comprising the following steps:
(a) providing a substrate having a top surface;
(b) providing a barrier layer comprising alumina and silica that suppresses monovalent metal ion migration at elevated temperature over the top surface of the substrate;
(c) providing soot particles; and
(d) collecting the soot particles on top of the barrier layer to form the silica-containing body at an elevated forming temperature in a furnace.

In a preferred embodiment of the process for making silica-containing body of the present invention, in step (b), the barrier layer provided suppresses the migration of monovalent metal ions selected from alkaline metal ions, Ag⁺, Cu⁺ and combinations thereof. Preferably, the barrier layer has a sodium diffusion coefficient at 1000° C. of less than 1×10⁻⁸ cm²/s, more preferably less than 1×10⁻¹⁰ cm²/s.

Desirably, the silica-containing body thus produced has monovalent metal ion concentration in the area abutting the barrier layer less than 50 ppb, preferably less than 20 ppb, more preferably less than 10 ppb, still more preferably less than 5 ppb, most preferably less than 1 ppb. Desirably, the silica-containing body thus produced has a sodium ion concentration in the area abutting the barrier layer less than 50 ppb, preferably less than 20 ppb, more preferably less than 10 ppb, still more preferably less than 5 ppb, most preferably less than 1 ppb.

In one embodiment of the process for forming silica-containing body of the present invention, in step (c), the soot particles are provided by flame hydrolysis process.

In one embodiment of the silica-containing body forming process of the present invention, in steps (c) and (d), the temperature is over 1500° C.

In one embodiment of the silica-containing body forming process of the present invention, an additional step (a1) is performed after step (a) but before step (b):
(a1) providing a bait sand layer different from the barrier layer on the top surface of the substrate;
   whereby in step (b), the barrier layer is formed on top of the bait sand layer. The bait sand layer may desirably have a monovalent metal ion, selected from alkaline metal ions, Ag⁺, Cu⁺ and combinations thereof, of content of up to 10 ppm, and a sodium content of up to 5 ppm.

In one embodiment of the process for forming silica-containing body of the present invention, in step (b), the material of the barrier layer is formed via flame hydrolysis process. The material of the barrier layer may comprise, for example, up to 8% by weight of Al₂O₃. The silica precursor material for the barrier layer can be silicon halides or organosilicon compounds. The alumina precursor material for the barrier layer can be organoaluminum compounds or aluminum halides for use in typical flame hydrolysis processes.

In one embodiment, the barrier layer is directly formed via flame hydrolysis process over the top surface of the substrate, preferably in the same furnace where the silicon-containing body is formed, with or without an intermediate bait sand layer between it and the substrate. Where an additional bait sand layer is used between the top surface of the substrate and the barrier layer, the barrier layer is directly formed on top of and abutting the bait sand layer. Preferably, the barrier layer is a continuous vitreous Al₂O₃—SiO₂ glass layer.

Alternatively, the material of the barrier layer may be ground glass particles of Al₂O₃—SiO₂ glass produced using the flame hydrolysis process, for example, the typical OVD or VAD process for producing waveguide fused silica material or the typical process for producing large fused silica boules described supra. The Al₂O₃—SiO₂ glass may be consolidated or unconsolidated.

Alternatively, the barrier layer may be bulk glass or a layer of ground powder of melted aluminosilicate glass essentially free of monovalent metal ion. Preferably, the glass is a La₂O₃—Al₂O₃—SiO₂ glass. Preferably, the glass has a high molar Al₂O₃ percentage of least 10%, more preferably at least 20%, still more preferably at least 30%. Preferably the glass has a Al₂O₃ molar percentage between 20-40%. Advantageously, the glass itself has a very low monovalent metal ion content of less than 800 ppb, preferably less than 500 ppb, more less than 300 ppb, still more preferably less than 100 ppb, still more preferably less than 50 ppb, most preferably less than 20 ppb. Advantageously, the glass itself has a very low Na content of less than 500 ppb, preferably less than 300 ppb, more preferably less than 100 ppb, still more preferably less than 50 ppb, most preferably less than 20 ppb.

Alternatively, the barrier layer is formed by depositing a sol-gel layer comprising silica and alumina. The sol-gel preferably is formed from an aqueous slurry formed by at least one hydrolysable silicon compound and at least one hydrolysable aluminum compound in an acidic aqueous medium. Preferably, the at least one hydrolysable silicon compound has the following general formula
Rₘ—Si—Xₙ (I),
where R independently is a non-hydrolysable group, X independently is a hydrolysable group, m is an integer from 0 to 3, inclusive, n is an integer from 1 to 4, inclusive, and m+n=4; and
the at least one hydrolysable aluminum compound is a compound having the following general formula
S₀—Al—Yₚ (II),
where S independently is a non-hydrolysable group, Y independently is a hydrolysable group, o is an integer from 0 to 2, inclusive, p is an integer from 1 to 3, inclusive, and o+p=3. Preferably, R and S independently are selected from the group consisting of optionally fluorinated C₁-C₂₄ alkyl and optionally fluorinated phenyl, X and Y independently are selected from the group consisting of hydrogen, halogen and OR′ where R′ is a C₁-C₄ alkyl.

The required thickness of the barrier layer depends on monovalent metal ion, particularly sodium, concentration ingredient between the substrate/bait sand and the silica-containing body to be formed as well as Al₂O₃ concentration in the barrier layer. For a substrate or bait sand used having a sodium concentration of about 5 ppm, a Al₂O₃—SiO₂ barrier layer comprising about 7 wt % Al₂O₃ about 2 cm thick is sufficient to suppress Na migration for the production of a high purity fused silica boule in a typical direct-deposit furnace, such that the sodium concentration in the boule produced is substantially reduced.

A third aspect of the present invention is a barrier material comprising alumina and silica for suppressing the migration of monovalent metal ion between inorganic materials at an elevated temperature, wherein the amount of alumina in the barrier material is between 3% and 90% by weight of the total amount of alumina and silica, and the barrier material has a sodium diffusion coefficient at 1000° C. of less than 1×10⁻⁸ cm²/s. Preferably, in the barrier material, the amount of alumina is between 5% and 80%, more preferably between 10% and 80%, still more preferably between 10% and 60%, still more preferably between 20% and 60%, of the total amount of alumina and silica. Preferably, the barrier material consists essentially of alumina and silica. Preferably, the barrier material has a sodium diffusion coefficient at 1000° C. of less than 1×10⁻¹⁰ cm²/s. Preferably, the barrier material has a monovalent metal ion concentration less than 50 ppm, preferably less than 30 ppm, more preferably less than 20 ppm, most preferably less than 10 ppm. Preferably, the barrier material has a sodium ion concentration less than 50 ppm, preferably less than 20 ppm, more preferably less than 5 ppm, most preferably less than 500 ppb. Preferably, for the best effect in suppressing the migration of monovalent metal ions, it is preferred that the silica and alumina distribute substantially evenly in the material. Preferably, the barrier material forms a continuous layer when subjected to the elevated temperature at which the material is used. For the production of HPFS® material, it is preferred that the barrier material forms a continuous layer at a temperature about 1500° C.

The present invention has the advantages of suppressing monovalent metal ions, especially alkali metal ions, particularly sodium ion, migration between inorganic materials at a relatively low cost. The barrier layer is easy to form and it suppresses sodium migration effectively. The barrier layer is easy to integrate into current HPFS® production furnaces to produce fused silica boules with significantly lower sodium concentration.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings:

FIG. 1 is a schematic illustration of the direct-deposit furnace for the production of fused silica boule;

FIG. 2 is a diagram of the electron microprobe analysis result of the Na and Al concentration of the Al-rich glass-fused silica sandwich of Example 1, moving from the Al-rich glass to the fused silica;

FIG. 3 is a diagram showing the Na concentration profile in the fused silica disk sample of Example 1, and an erfc fit curve thereof;

FIG. 4 is a diagram showing the curve of calculated diffusion coefficient of fused silica as a function of temperature at elevated temperatures;

FIG. 5 is a schematic illustration of how the sample section of Example 2 is taken from the center of the boule produced in the single burner refractory furnace;

FIG. 6 is a schematic illustration of how the center section taken from the center of the boule produced in Example 2 is further sliced into test sample subsections;

FIG. 7 is diagram showing the concentration of sodium as a function of distance from the top of the boule produced in Experiments A, B, C and D of Example 2;

FIG. 8 is a partial enlargement of the diagram of FIG. 7 to show more details;

FIG. 9 is a diagram showing the correlation between the aluminum concentration in the barrier layer/bait material and sodium concentration at various distances from the top of the boules in the fused silica boules produced in Example 2.

### DETAILED DESCRIPTION OF THE INVENTION

As used herein, the term “fused silica” includes undoped high purity fused silica and fused silica materials with various amounts of dopants, such as fluorine, aluminum, titanium, and the like, unless otherwise specified. The term “elevated temperature” means a temperature higher than 500° C., preferably higher than 800° C., more preferably higher than 1000° C., still more preferably higher than 1500° C. The term “monovalent metal ion” means ion and ions selected from the group consisting of alkali metal ions, Ag⁺ and Cu⁺.

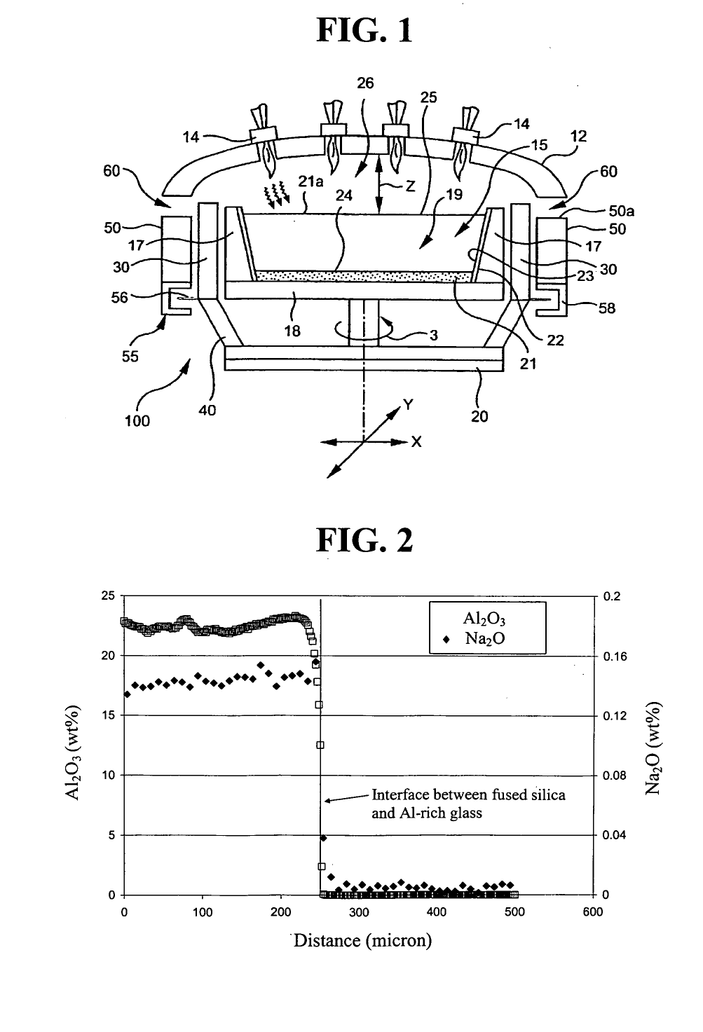

FIG. 1 shows a typical direct-deposit furnace 100 for producing fused silica glass. The furnace includes a crown 12 and a plurality of burners 14 projecting from the crown. Silica particles are generated in a flame when a silicon containing raw material together with a natural gas is passed through the plurality of burners 14 into the furnace chamber 26. These particles are deposited on a hot collection surface of a rotating body where they consolidate to the solid, glass state. The rotating body is in the form of a refractory cup or containment vessel 15 having lateral walls 17 and a collection surface 21 which surround the boule 19 and provide insulation to the glass as it builds up. The refractory insulation ensures that the cup interior and the crown are kept at high temperatures.

The furnace further includes a ring wall 50 which supports the crown 12. The furnace further includes a rotatable base 18 mounted on an oscillation table 20. The base is rotatable about an axis 3. The crown 12, the ring wall 50, the base 18 and the lateral walls 17 are all made from suitable refractory materials.

The cup or containment vessel 15 is formed on the base 18 by means of lateral cup walls or containment walls 17 mounted on the base 18, which forms the cup or containment vessel 15. The lateral cup or containment walls 17 and the portion of the base 18 surrounded by the walls 17 is covered with high purity bait sand 24 which provides collection surface 21 for collecting the initial silica particles produced by the burners 14. Bait sand used may be, for example, ground zircon (ZrO₂.SiO₂) or zirconia (ZrO₂) particles. During deposition and consolidation of the silica particles into a solid glass, the boule 19 is formed having sidewalls 23 and an upper major surface 25. As the boule 19 is formed during the deposition process, the upper major surface 25 of the boule 19 becomes the collection surface 21a for the silica particles. The burners 24 and the collection surface 21a have a distance z. The lateral walls 17 can be made from refractory blocks such as alumina base block for forming the walls 17 and an inner liner made of a suitable refractory material such as zircon or zirconia.

Surrounding the lateral walls 17 of the cup or containment vessel 15 is a shadow wall or air inflow wall 30. The shadow wall 30 is mounted on x-y oscillation table 20 by feet 40, for example four feet equally spaced around the circumference of the shadow or air inflow wall 30. Details on the construction a shadow wall and a furnace using a shadow wall may be found in U.S. Pat. No. 5,951,730, the entire contents of which are incorporated herein by reference. Other ways of mounting the air inflow wall to the oscillation table can be used if desired. The stationary ring wall 50 surrounds the ring wall and supports the crown 12. A seal 55 is provided between the stationary ring wall 50 and the air flow wall or shadow wall 30. The seal 55 includes an annular plate 56, which rides in or slides in an annular channel 58 formed within the stationary ring wall 50. The annular channel 58 can include a C-shaped annular metal plate which forms the bottom of the stationary wall. Other forms of motion-accommodating seals can be used if desired, including flexible seals composed of flexible metal or refractory cloth, which, for example, can be in the form of bellows.

The products of combustion in the furnace 100 are exhausted through ports 60 circumferentially spaced around the furnace. In a typical furnace, six ports 60 are provided, and the ports 60 are located between crown 12 and the top edge 50a of the stationary wall, such that the ports 60 are located above the deposition surface 21 and 21a during formation of the boule.

Boules typically having diameters on the order of five feet (1.5 meters) and thicknesses on the order of 5-10 inches (13-25 cm) can be routinely produced in large production furnaces of the type shown in FIG. 1. Multiple blanks are cut from such boules and used to make the various optical members referred to above. The blanks are generally cut in a direction parallel to the axis of rotation of the boule in the production furnace, and the optical axis of a lens element made from such a blank will also generally be parallel to the boule's axis of rotation in the furnace. For ease of reference, this direction will be referred to as the “axis 1” or “use axis”.

As discussed supra, sodium containment in the boules should be avoided at all costs. The transmission penalty at 193 nm for sodium in fused silica material, such as Corning 7980 and 7990 glasses, is about 0.006%/cm/ppb. Other monovalent metal ions, especially alkali metals, such as potassium is detrimental to the optical properties, especially transmission properties of the HPFS® materials as well. Less sodium in the boules would have several major impacts, inter alia: (i) transmission at deep and vacuum UV will be improved; (ii) fluorescence of the glass will be reduced; and (iii) more useable glass could be extracted form the boule, from both its radius and depth. Unfortunately, sodium is an ubiquitous contaminant in most materials, particularly natural-derived materials such as the bait sand and refractories used to manufacture HPFS®. The exact origins of the sodium are unknown. As discussed above, it has been surmised that the sodium may have been mobilized from the refractory bricks in building the furnace, and accordingly methods such as reducing brick temperature at the burner holes and reducing sodium content in the refractories have been proposed to reduce sodium level in the boule.

It is known that sodium diffusion in pure silica is extraordinarily rapid, on the order of 10⁻⁶ cm²/sec at a temperature as low as 1000° C. For example, in the Encyclopedia of Chemical Technology, volume 21, page 1047, it is disclosed that the diffusion coefficient of sodium ion in vitreous silica at 1000° C. is 7.9×10⁻⁶ cm²/s. The research of Dieckmann et al. using ²²Na tracer diffusion gave similar result. See Lei Tian, Rudiger Dieckmann et al., Effect of water incorporation on the diffusion of sodium in Type I silica glass, Journal of Non-Crystalline Solids (2001), page 146-161. The mean diffusion path length is therefore ˜\sqrt{2Dt}, which translates to approximately 1 mm per hour at 1000° C.

Dieckmann has found that the presence of aluminum oxide drastically decreases the diffusion coefficient for sodium in silica, such that at 25 mol % Al₂O₃ the diffusivity is down 6 orders of magnitude relative to silica at the same temperature.

The present inventors have found compelling evidences indicating that the primary source of sodium in the boules produced, for example, in a furnace of the type of FIG. 1, is the brick in the cup and the bait sand of the laydown furnace. While chlorine treatment reduces the total amount of sodium available, approximately 3 ppm sodium is routinely retained in the bricks and bait sand. This sodium is not susceptible to removal by either chlorine treatment or aggressive acid leaching. However, the present inventors believe that, the sodium is readily mobilized simply by heating the brick up to temperatures in excess of 1000° C. While not intending to be bound by any particular theory, it is believed that the sodium originates largely from the use of sodium metasilicate hydrate (“water glass”) as a binder in brick fabrication and from the bait sand, especially during the early stages of laydown. The fact that sodium diffuses very rapidly in vitreous fused silica at elevated temperature explains why sodium is present is so many places in the final silica boule. Indeed, it is now found that sodium concentration gradient exists in the boules produced which decreases from the bottom (closer to the bait sand) to the top (closer to the burners). This strongly suggests that the primary sodium source is the bait sand and the refractory cup below.

Based on the above understandings, the instant inventors made the present invention with the aim to suppress sodium migration from one material, for example, the bait sand or the refractory of the cup, to another, for example, the fused silica boule formed over the bait sand. The present invention achieves this goal by using an aluminum-containing barrier layer between the sodium source material and the potential sodium recipient material. Because the diffusion behavior of monovalent metal ions in inorganic materials at elevated temperatures share a lot of similarities, it is believed that the present invention processes are applicable for other monovalent metal ions, including other alkali metal ions, Ag⁺ and Cu⁺. The present invention will be described particularly in connection with sodium ion because it is an important ion in the production and working of HPFS® materials. However, it is to be noted that the present invention is not merely applicable for suppressing Na migration.

The processes of the present invention will be described in more detail as follows.

A first aspect of the present invention is directed to a general process for suppressing sodium migration from a first inorganic material to a second inorganic material at an elevated temperature. Diffusion of sodium ions in solid materials have been researched and studied in the art. The diffusion examined includes, for example, surface diffusion, grain boundary diffusion (diffusion along the grain boundary of crystalline or non-crystalline materials), volume diffusion (diffusion within the body of a bulk crystalline or non-crystalline articles). Generally, surface diffusion and grain boundary diffusion are much faster than volume diffusion. Normally, when two solid inorganic materials having substantially different sodium concentrations are placed into contact with each other, thermodynamically sodium ions tend to diffuse from the higher concentration area to the lower concentration area. At low temperature, for example, room temperature, the diffusion may not be very noticeable. However, at an elevated temperature, for example, at the typical temperature at which fused silica glass is produced in a FIG. 1 furnace, about 1650° C., such diffusion becomes much faster. Therefore, sodium diffusion and contamination becomes a problem when materials are produced or worked at an elevated temperature on a substrate having higher sodium concentration.

As discussed supra, the presence of Al₂O₃ in silica drastically reduces the diffusivity of sodium in silica, such that at 25% by mole Al₂O₃ the diffusivity is down 6 orders of magnitude relative to silica at the same temperature. The process of the present invention for suppressing sodium (and other monovalent metal ions) migration from one inorganic material to another takes advantage of this interesting property. This process may be advantageously employed in the production and processing of any high purity inorganic materials for which sodium contamination poses a problem. Whereas the present invention is primarily described in the context of the production of high purity fused silica (HPFS®) material in a high temperature furnace using flame hydrolysis process, it is to be understood that the process may be also used in many other processes in which high purity materials are susceptible to exposure to high monovalent metal ion concentration environment. For example, the present invention process may be used for the production and processing (annealing, for example) of other high purity materials, such as CaF₂ and MgF₂ crystals. For another example, the present invention may be used in processes in which high purity fused silica is worked, such as molding and sagging of HPFS® to produce optical members, and consolidation of porous fused silica bodies.

The barrier layer may contain Al₂O₃ in the amount, by weight, from 1% to 99%, preferably from 3% to 90%. The barrier layer may contain, in addition to Al₂O₃ and SiO₂, other metals, especially multiple-valent metals, having a low diffusivity at elevated temperature, for example, Ca, Mg, La, and the like. The barrier layer may contain a higher amount of monovalent metal ions than in the second inorganic material. However, for a second inorganic material desired to have a sodium concentration lower than 100 ppb, it is desired that the barrier layer has a sodium concentration lower than 1000 ppb, preferably lower than 500 ppb. It is desired that the barrier layer, when heated to the elevated operation temperature, forms an essentially continuous layer, whereby grain boundary diffusion is minimized. The thickness of the barrier layer depends on, inter alia, the monovalent ion concentration gradient between the first and second inorganic materials, the temperature profile to which the materials are both exposed, and the requirement as to the monovalent metal ion level in the second inorganic material. Generally, a higher Al₂O₃ content in the barrier material is desired, because volume diffusion in barrier materials with higher Al₂O₃ tends to be slower.

Preferably, the barrier layer material has a sodium volume diffusion coefficient at 1000° C. of less than 1×10⁻⁸ cm²/s, more preferably less than 1×10⁻¹⁰ cm²/s, especially when it is used in connection with the production and/or processing of HPFS® materials.

The barrier layer used between the first inorganic material and the second inorganic material may be produced by various methods. The material of the barrier layer may be produced using conventional flame hydrolysis of typical silicon and aluminum precursor materials, such as silicon halides, organosilicon compounds, aluminum halides and organoaluminum compounds. The advantage of this method is the possibility of obtaining a barrier layer with very low monovalent metal ion, especially sodium ion, concentration. The glass may be produced using the waveguide process, or by a direct process in a furnace such as the one illustrated in FIG. 1. The glass may be porous or consolidated. Preferably, the glass is consolidated. If the glass is porous, it may be further solution-doped with Al₂O₃. Alternatively, the barrier layer material may be produced by solution doping a porous HPFS® body essentially free aluminum produced using flame hydrolysis methods available in the art, with aluminum-containing solutions. Solution doping methods are described in, for example, U.S. Pat. Nos. 5,151,117, 5,236,481 and 6,474,106, the disclosure of which are relied upon and incorporated herein by reference in their entirety.

Such barrier layer may be formed directly on a contacting surface of the first inorganic material, a contacting surface of the second inorganic material, or both. This approach is advantageous where the second inorganic material is produced over the surface of a substrate of the first inorganic material, and the second inorganic material as well as the barrier layer can be produced by using the same equipment. For example, in a furnace of FIG. 1 where fused silica is produced in a cup made of zircon using zircon bait sand, it is advantageous to lay down a layer of Al doped fused silica over the zircon bait before the laydown of the fused silica boule. Alternatively, the barrier layer may be formed of ground glass particles formed by flame hydrolysis.

As mentioned supra, the material of the barrier layer may be melted aluminosilicate glass. It is known that high aluminum silicate glass, such as CaO—Al₂O₃—SiO₂ and La₂O₃—Al₂O₃—SiO₂ glasses can be melted. Such glass should be advantageously low in monovalent metal ions, especially alkali metal ions, such as sodium and potassium, which are prone to diffusion at elevated temperatures. Therefore, high purity reagents must be used in preparing such melted glass. One exemplar of this type of glass would have a composition, by mole, 6% La₂O₃, 22% Al₂O₃ and 72% SiO₂, which is a viscous melt at temperatures characteristic of HPFS® laydown. Lanthanum will have a diffusion coefficient comparable to aluminum, and therefore will not represent a significant contamination problem for HPFS®. The melted glass may be reduced to particles and then deposited as the barrier layer. In this case, it is desired that the powder forms a substantially continuous layer at the elevated temperature to which the first and second inorganic materials are exposed to. Alternatively, a piece of bulk glass may be placed directly between the first and second inorganic materials as the barrier layer. Preferably, the glass has a high molar Al₂O₃ percentage of at least 10%, more preferably at least 20%, still more preferably at least 30%. Preferably the glass has a Al₂O₃ molar percentage between 20-40%. Advantageously, the glass itself has a very low monovalent metal ion content of less than 800 ppb, preferably less than 500 ppb, more less than 300 ppb, still more preferably less than 100 ppb, still more preferably less than 50 ppb, most preferably less than 20 ppb. Advantageously, the glass itself has a very low Na content of less than 500 ppb, preferably less than 300 ppb, more preferably less than 100 ppb, still more preferably less than 50 ppb, most preferably less than 20 ppb.

The barrier layer material may be prepared by using sol-gel processes. A typical sol-gel process for producing Al₂O₃—SiO₂ glasses uses the hydrolysis of hydrolysable silicon and aluminum compounds in an aqueous medium to produce the sol-gel slurry, followed by drying, optional oxidation (such as heating in the presence of oxygen, for example, in air, O₂—N₂ mixture, O₂—He mixture, and the like) where necessary (for example, where organic moieties are present in the sol-gel) and optional consolidation to form solid Al₂O₃—SiO₂ material. The hydrolysable silicon compounds are represented by the following general formula:
Rₘ—Si—Xₙ (I),
where R independently is a non-hydrolysable group, X independently is a hydrolysable group, m is an integer from 0 to 3, inclusive, n is an integer from 1 to 4, inclusive, and m+n=4.

The hydrolysable aluminum compounds are represented by the following general formula
Sₒ—Al—Yₚ (II),
where S independently is a non-hydrolysable group, Y independently is a hydrolysable group, o is an integer from 0 to 2, inclusive, p is an integer from 1 to 3, inclusive, and o+p=3.

Preferably, R and S are independently halogen, hydrogen and OR′ where R is a C₁-C₄ alkyl. Preferably, X and Y independently are optionally fluorinated C₁-C₂₄ alkyl and optionally fluorinated phenyl. Non-limiting examples of compound (I) include: SiCl₄, Si(OCH₃)₄ and Si(OCH₂CH₃)₄. Non-limiting examples of compounds (II) include: AlCl₃, (i-Pr—O)₃Al and (sec-C₄H₉—O)₃Al. An exemplar of such a sol-gel would be a 90-10 (by mole) mixture (Si and Al, respectively) of tetraethoxysilane and aluminum isopropoxide combined with a 4:1 molar ratio of pure 0.01 N hydrochloric acid. Non-contaminating refractory particles, such as α-Al₂O₃ particles, may be added to the slurry as well.

The hydrolysable silicon and aluminum compounds are allowed to hydrolyze in an aqueous medium, for example, an acidic alcohol aqueous medium, pre-condensed and aged to form a slurry, then dried to remove the liquid to obtain a porous network of Al₂O₃—SiO₂ material.

An alternative of the sol-gel process is to hydrolyze a hydrolysable silicon compound of formula (I) in a suspension of alumina particles, followed by drying, optional oxidation and consolidation as described above.

The slurry or the dried porous material may be deposited to form the barrier layer directly. For example, in a furnace of FIG. 1, the slurry or the porous material may be used solely to form the bait material at the bottom of the cup. When the furnace temperature is gradually raised to an elevated temperature, the slurry will first dry up to form the porous material, then densify in situ to form the barrier layer at the bottom of the cup. Alternatively, a layer of typical bait sand (zircon or refractory alumina bait sand, for example) is first deposited at the bottom of the cup and a layer of the slurry or porous Al₂O₃—SiO₂ dried gel is deposited on top of the bait sand layer thereafter. In this scenario, a barrier layer will form between the bait sand layer and the fused silica layer when the furnace temperature is brought up to the elevated temperature where the fused silica boule is formed.

Still alternatively, the dried porous Al₂O₃—SiO₂ sol-gel material may be consolidated at an elevated temperature, crushed and then used as the barrier layer material either directly over the cup bottom or over an intermediate bait sand layer.

The sol-gel process for the formation of the barrier layer is particularly advantageous for the following reasons. First, high purity Al₂O₃—SiO₂ material can be formed by using high purity precursor silicon and aluminum compounds and other reagents. Second, high proportion of Al₂O₃ can be achieved in the barrier layer. Third, the possibility of using a slurry to form the barrier layer makes it suitable for insulating substrates and bait sand layers having irregular surface. Finally, the porous dried Al₂O₃—SiO₂ gel can densify into a consolidated glass at a relatively low temperature, for example, 1200° C., well below the laydown temperature of the fused silica in a furnace of FIG. 1, which is typically 1650° C. Thus potentially a continuous barrier layer of Al₂O₃—SiO₂ material can be formed well before the actual laydown of fused silica boule. A continuous barrier layer is believed to be particularly effective to suppress sodium migration (and other monovalent metal ions) given that grain boundary diffusion is eliminated.

Another aspect of the present invention is directed to an improved process for making fused silica body comprising the following steps:

(a) providing a substrate having a top surface;
(b) providing a barrier layer comprising alumina and silica that suppresses monovalent metal ion migration at elevated temperature over the top surface of the substrate;
(c) providing soot particles at an elevated temperature; and
(d) collecting the soot particles on top of the barrier layer to form the silica-containing body at an elevated forming temperature in a furnace.

The substrate provided in step (a) can be the cup bottom 18 of the refractory cup in the furnace of FIG. 1, the mandrel in an OVD (outside vapor deposition) process, and the like. The substrate may have a monovalent metal ion concentration of up to 800 ppm, and a sodium concentration up to 500 ppm. As is mentioned supra, sodium concentration in the zircon cup refractory used in the FIG. 1 fused silica furnace typically contains about 3 ppm sodium. However, in order to produce HPFS® material, especially those qualified for 193-nm lithographic applications, it is desired that the substrate has a relatively low monovalent metal ion concentration of below 100 ppm, preferably below 50 ppm, and a sodium concentration of below 80 ppm, preferably below 30 ppm.

The barrier layer in step (b) is provided substantially in the ways as described supra in connection with the process for suppressing sodium migration of the present invention. The barrier layer material may be formed by flame hydrolysis process, by melting aluminosilicate glasses, or by sol-gel processes. The barrier layer may be the sole bait material used in the process for making fused silica body, or may be applied on top of an existing bait sand made of, for example, typical zircon materials or refractory alumina. The barrier layer may be deposited in ways described supra in connection with the process for suppressing monovalent metal ion migration of the present invention. Referring to FIG. 1, the barrier layer may be deposited on top of the bait sand layer 21 before the laydown of the fused silica boule 19. The bait sand material may have a monovalent metal ion concentration up to 800 ppm, and a sodium concentration up to 500 ppm. As is mentioned supra, sodium concentration in the zircon bait sand used in the FIG. 1 fused silica furnace typically contains about 3 ppm sodium. However, in order to produce HPFS® material, especially those qualified for 193-nm lithographic applications, it is desired that the intermediate bait sand has a relatively low monovalent metal ion concentration of below 100 ppm, preferably below 50 ppm, and a sodium concentration of below 80 ppm, preferably below 30 ppm.

The step (c) can be carried out according to any method used in the art of making fused silica material. For example, the soot may be produced in a flame hydrolysis process such as the VAD, OVD processes, or direct deposit process using the furnace of FIG. 1. Alternatively, the soot particles may be provided by using a plasma-assisted process. The soot particles comprise the particles of silica and optional dopants, such as alumina, titania, and the like. Likewise, step (d) is typically carried out in accordance with the conventional fused silica making processes. The fused silica body thus produced in step (d) may be consolidated or porous. The temperature required for the production of porous bodies is usually lower than for the production of consolidated body if the same furnace is used. If porous body is produced in step (d), the porous body may be further doped before densification into a consolidated glass at an even higher temperature. Methods for doping porous fused silica bodies are disclosed, for example, in U.S. Pat. Nos. 5,151,117, 5,236,481 and 6,474,106, the disclosure of which are relied upon and incorporated herein by reference in their entirety.

A third aspect of the present invention is the barrier material per se. The barrier material can be prepared according to any of the means discussed supra in connection with the process for suppressing monovalent ion migration of the present invention. The barrier material should advantageously comprise Al₂O₃ between 3% and 90% by weight, preferably between 5% and 80%, more preferably between 10% and 80%, still more preferably between 20% and 60%, of the total amount of alumina and silica. The barrier material has a sodium diffusion coefficient at 1000° C. of less than 1×10⁻⁸ cm²/s. Preferably, the barrier material consists essentially of alumina and silica. Preferably, the barrier material has a sodium diffusion coefficient at 1000° C. of less than 1×10⁻ cm²/s. Preferably, the barrier material has a monovalent metal ion concentration less than 50 ppm, preferably less than 30 ppm, more preferably less than 20 ppm, most preferably less than 10 ppm. Preferably, the barrier material has a sodium ion concentration less than 50 ppm, preferably less than 20 ppm, more preferably less than 5 ppm, most preferably less than 500 ppb. The barrier material of the present invention is effective in suppressing migration of monovalent metal ion, especially alkali metal ion, particularly sodium, between inorganic materials at an elevated temperature. Preferably, for the best effect in suppressing the migration of monovalent metal ions, it is preferred that the silica and alumina distribute substantially evenly in the material. Preferably the barrier material forms a continuous layer when subjected to the elevated temperature at which the material is used. For the production of HPFS® material, it is preferred that the barrier material forms a continuous layer at a temperature higher than 1500° C.

The following non-limiting examples further illustrate the present invention.

### EXAMPLES

### Example 1

This Example shows that sodium ion diffusion is much slower in an Al-rich glass than in fused silica.

A 193 nm-quality HPFS® cylinder having sodium concentration less than 50 ppb was core-drilled to obtain a 2″ diameter boule. The boule was sliced into ¼″ thick disks. One face of the disks was ground to an optical polish. Each disk was leached in a mixture of 5% HCl, 5% nitric acid and 5% HF for 10 minutes in a clean Teflon® beaker inserted in an ultrasonic bath. The leached disks were sonicated 3 more times in triply deionized water, then dried in air on a clean plastic sheet. A calcium aluminosilicate glass (hereinafter “Al-rich glass”) having a composition, in mole percentage, of 63% SiO₂, 20.5% Al₂O₃ and 16.5% CaO, was melted. A patty of the glass was core drilled to produce disks identical in size of the corresponding HPFS® disks, again with one face taken to an optical polish. These Al-rich glass disks were leached and dried as above for the HPFS® disks.

Five grams of sodium metasilicate hydrate was dissolved into an equal mass of triply deionized water. Then a single drop (˜100 μl) of the solution was dropped on the polished face of an HPFS® disk. A polished face of one of the Al-rich glass disk was then placed onto the droplet and forced against the HPFS® until most of the solution squirted out the sides. The two disks were carefully separated and placed in a small resistance furnace to dry at 120° C. After ten minutes, the opposing polished faces were once again brought together, and this “sandwich” was heated 10 minutes at 1000° C. to drive off any remaining water from the water glass. The sandwich was then placed on a pre-heated block of silica refractory and plunged into a furnace at 1600° C., aluminosilicate-side down.

After 20 minutes, the sandwich was removed from the furnace and was found to be bound firmly to the refractory block. The sandwich plus refractory block was immersed in a stream of cold flowing water and was held there until the hissing stopped (˜150° C.). This took about 5 minutes, but the sample was no longer incandescent in less than 1 minute. This rapid quench broke the seal between the aluminosilicate glass and refractory block. The two disks were considerably shattered by the rapid quench and large difference in their CTEs, but several 0.5-1 cm pieces with intact boundary layers were recovered. One of these was submitted for microprobe analysis.

FIG. 2 shows the microprobe analysis result moving from the surface of the Al-rich glass into the HPFS® sample. It is clear from this figure that aluminum is almost completely immobilized in the Al-rich glass and did not migrate into the HPFS® sample. It is also clear that sodium concentration in the Al-rich glass was much higher than that in the HPFS® sample. Sodium was essentially below detection limits in the HPFS® sample near the interface. Clearly at the boundary of the Al-rich glass and the HPFS® sample, there is a sharp drop of sodium concentration. This indicates that the sodium ions contained in the Al-rich glass has limited mobility which prevents them from migrating into the HPFS® sample, suggesting that the sodium ions are trapped in the Al-rich glass.

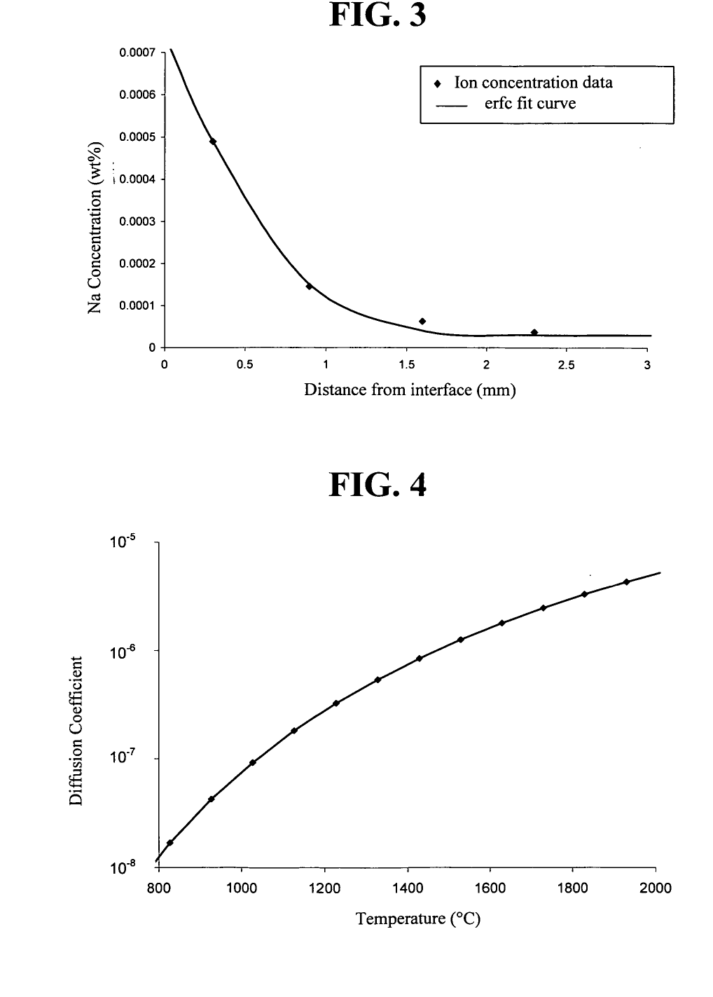

The sample was further examined using dynamic second ion mass spectroscopy. Though this method lacks the spatial resolution of microscope, its dynamic range is far greater, and it was expected that sodium in the HPFS® sample could be detected. Indeed, a sodium diffusion profile was detected that extended nearly 2 mm into the HPFS® sample and away from the interface. This profile and an erfc fit curve are shown in FIG. 3.

The implied diffusivity of sodium calculated from the erfc fit curve at 1600° C., 1.8×10⁻⁶ cm²/s, is extraordinarily fast. Using the equation for rms diffusion distance, this corresponds to 19 μm/s, or 1.1 mm/hour. Since the rms diffusion distance corresponds to the 1/e concentration relative to the peak, sodium originating from only one face of the HPFS® slab would actually extend several millimeters into HPFS® after an hour.

It is known that in commercial production of HPFS® in direct deposit furnaces as illustrated in FIG. 1, the growth rate of HPFS® boule is on the order of millimeters per hour. If the bait sand having direct contact with the fused silica boule has a high Na concentration, for example, 3 ppm (which is the case of some zircon bait), and the sodium is easily mobilized at the laydown temperature of the boule, a natural conclusion would be the sodium would then move from the bait sand and distribute throughout the boule, inasmuch as the sodium diffusion rate is comparable to the boule growth rate.

Zircon refractories, including the cup substrate and the bait sand, were usually chlorine treated to reduce sodium. We performed experiments to find that the residue sodium in the zircon refractories, usually about 3 ppm, was not susceptible for further chemical removal using acid leaching. However, once they were subjected to an elevated temperature, such as a temperature over 1000° C., sodium was mobilized.

It has also been found that a sodium gradient exists in HPFS® boules produced in FIG. 1 furnaces where zircon bait sand and zircon refractory cups having sodium in the ppm level were used. Sodium concentration in these boules from the bottom of the boule (closer to the bait sand) to the top of the boule (closer to the burners).

Based on these experiments and evidences, we came to the conclusion that most, if not all, sodium ions in HPFS® boules produced in furnaces of FIG. 1 using typical bait sand and refractory having sodium in the ppm level, originates from the sodium containing cup substrate and/or the bait sand.

An approximation of sodium diffusion at any temperature was conducted using the activation energy of 100 kJ/K·mol determined by Dieckmann et al. The result of the calculation is shown in FIG. 4. It is surprising to find that between 1400° C. and 2000° C., the diffusivity changed by only about a factor of five; in other words, the rms diffusion length of sodium only changes by about 2 times over this wide range of temperature. Therefore, the precise temperature at the bottom of a HPFS® boule produced in a FIG. 1 furnace is not particularly important as far as the final sodium profile is concerned. It is thus expected that the diffusion rate is comparable to the laydown rate, and because of the large amount of refractory and bait sand at the base of the boule, there is effectively an infinite supply of sodium to contaminate HPFS® if the refractory and bait sand contain sodium in the ppm level.

Therefore, from this Example, it is clear that a barrier layer between (1) the bait sand, or the refractory substrate of the cup, having sodium in the ppm level, and (2) the HPFS® boule, which functions to suppress the sodium migration from the refractories and bait sand to the HPFS® boule above, can reduce the sodium level in the fused silica boule produced. This Example also indicates that an Al-containing glass may be capable of suppressing sodium migration if used as a barrier layer, inasmuch as sodium ions in the Al-containing glass are immobilized.

### Example 2

In this example, several bait materials were tested in a single burner refractory furnace for their influence on the sodium concentration of fused silica boule produced.

The single-burner furnace comprises a metal frame holding a 3″ thick refractory ringwall and a rotating center base or turntable. The turntable comprises a refractory sub-base, base and cup. The crown, ringwall, cup, and cup liners are made from zircon refractory. The crown and cup liners have been cleaned through a purification process called calcining which involves heating the refractory to an elevated temperature in a chlorine/helium atmosphere. The turntable rotates and can also be raised and lowered; this controls the size of the gap between the crown and top of the cup, which, in turn, controls the temperature of the glass during forming.

All parameters were duplicated run-to-run as close as possible. The crown refractory can be used for multiple runs. New cup liners are used for each run as they become fused to the boule during each run and break up on cooling and can not be reused. Three types of bait material were used: crushed zircon brick, Mintec cullet, and Al-doped optical waveguide glass. Concentrations (ppm) of metals contained in these bait materials obtained by chemical analysis are shown in TABLE 1. The bait materials were:

Crushed zircon brick (“Zircon Bait” in TABLE 1): This bait material was made from used production furnace crown bricks, which were crushed, run through a magnetic separator (to remove iron particles) and sized. This bait was used in all four runs, approximately 1000 grams was used and placed in the bottom of the cup alone or as the first layer.

Mintec glass cutlet (“Mintec Bait” in TABLE 1): This was produced from the webbing material left from HPFS® production boules after all usable parts were extracted. The webbing was crushed, run through an iron separator, sized, and acid-washed.

Al-doped optical waveguide glass (“OWG Bait” in TABLE 1): This glass was received as a consolidated waveguide blank with about 1″ diameter, weighing about 1000 grams. The blank was placed in a heavy plastic bag and broken into chunks, the largest about ¼″ across.

TABLE 1
Part I

| | Al | Na | Fe | Ti | Cr | Cu | Li | Mg |
|---|---|---|---|---|---|---|---|---|
| Zircon Bait | 1700 | 1.58 | <1 | 367 | 2.85 | <1 | <1 | 1.89 |
| Mintec Bait | 15 | 1.63 | 0.32 | 1.10 | 0.04 | 0.01 | 0.48 | 0.47 |
| OWG Bait | 14500 | 0.38 | 0.04 | 0.36 | 0.00 | 0.00 | 0.00 | 0.32 |

Part II

| | Ni | U | V | Zn | Zr | Ca | Ce | K |
|---|---|---|---|---|---|---|---|---|
| Zircon Bait | <1 | 207 | 11.72 | <2 | n/a | 3.72 | <5 | 2.07 |
| Mintec Bait | 0.03 | 0.09 | 0.00 | 0.01 | 1.84 | 1.00 | 0.07 | 0.91 |
| OWG Bait | 0.00 | <0.0001 | <0.0001 | 0.00 | 0.00 | 0.08 | <0.0005 | 0.02 |

The actual furnace runs comprised a pre-heat where the burner was ignited with the turntable in the lowest position. Over a period of 1.5 hours, the gas flows were increased to the required flows and the crown-cup gap was reduced until the required crown temperature of 1660° C. to 1670° C. was achieved. At this point the silicon precursor flow was started and glass formation began.

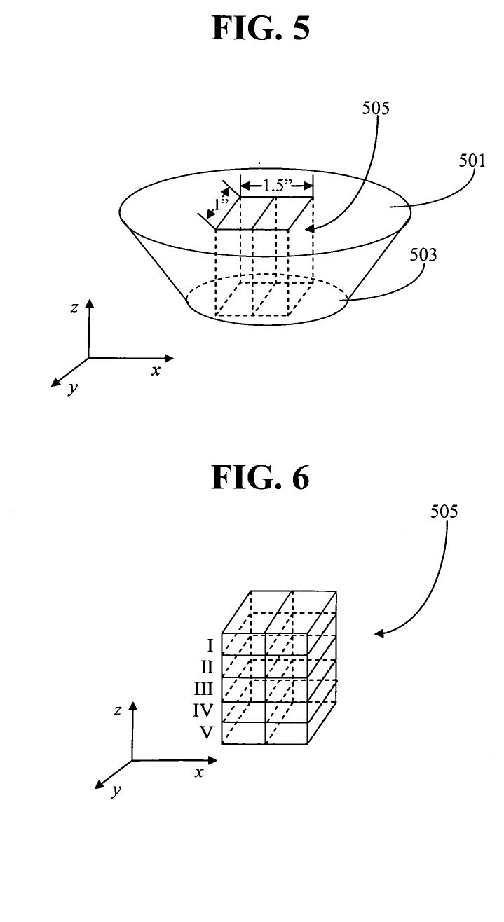

Glass formation continued for about 7 hours, which formed a boule averaging 1.5″ thick. The silicon precursor flow was first shut down and then all gas flows were shut down and the furnace was allowed to cool. The boule was then removed from the cup and cut into samples for analysis. The boule is schematically shown in FIG. 5, where 501 is the top surface and 503 is the bottom, which may include part of the bait sand or barrier layer.

As shown in FIGS. 5 and 6, a 1.5″×1″ section 505 was cut from the center of each boule and then sliced into 5 mm thick subsections. These subsections were labeled as sections I, II, III, IV, V, . . . , successively. Each subsection was cut in half (along the 1.5″ dimension) to provide two 1″×¾″ samples for duplicates. The samples were typically cleaned in HF, HNO₃ and HCl for multiple times before analysis.

Four experiment runs A, B, C and D were conducted. In these experiments, the combination of bait materials for each experiment is described below, and TABLE 2 shows the gas flows used for these runs and the boule thickness that resulted.

Experiment A: 1000 grams of crushed zircon bait were placed in the cup bottom and leveled. Fused silica glass was directly deposited on the zircon. A new crown was used for this experiment, which served as a conditioning run. The same crown was used for Experiments B, C and D.

Experiment B: 1016 grams of crushed zircon were placed in the cup bottom and leveled, followed by 586 grams of crushed OWG bait that was evenly placed directly over the crushed zircon.

Experiment C: 1004 grams of crushed zircon were placed in the cup bottom (identical conditions to Experiment A).

Experiment D: 976 grams of crushed zircon were placed in the cup bottom and leveled, topped by 1000 grams of Mintec bait, evenly placed over the crushed zircon.

TABLE 2

| | Inner | Outer | | | | | | |
|---|---|---|---|---|---|---|---|---|
| | Shield | Shield | Premix | Premix | Fume | | Run | Glass |
| | O₂ | O₂ | O₂ | CH₄ | N₂ | OMCTS | Time | thickness |
| Experiment | (slpm) | (slpm) | (slpm) | (slpm) | (slpm) | (gm/min) | (hours) | (inches) |
| A | 8 | 16 | 21.5 | 20 | 5.4 | 6.6 | 7.25 | 1.25 |
| B | 8 | 16 | 21.5 | 20 | 5.4 | 6.6 | 7 | 1.75 |
| C | 8 | 16 | 21.5 | 20 | 5.4 | 6.7 | 7.5 | 1.63 |
| D | 8 | 16 | 21.5 | 20 | 5.4 | 6.6 | 7 | 1.75 |

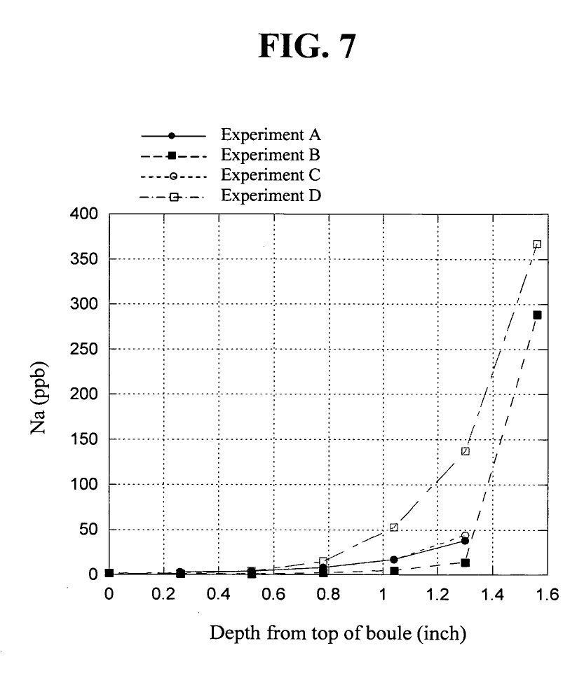

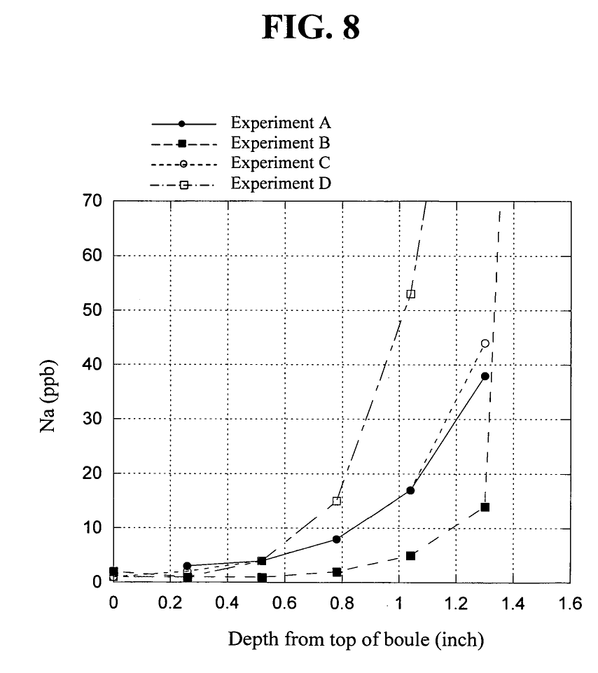

The glass samples were analyzed by traditional wet chemistry and inductively coupled plasma/mass-spectrometry (ICP/MS) techniques. The detected sodium concentration in the boules as a function of depth form the top is shown in FIGS. 7 and 8. FIG. 8 is a partial enlargement of FIG. 7.

The two repeating experiments, Experiments A and C, were glass deposited directly on crushed zircon ceramic. The chemistry of the two samples matched very well indicating that the technique is repeatable. The glasses were deposited on glasses in Experiments B and D.

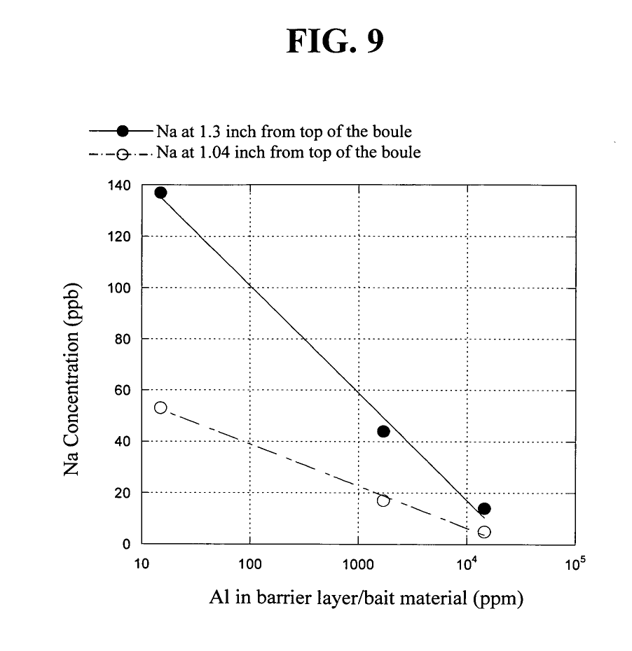

The plot in FIG. 9 illustrates that the Na in the deposited glass correlated well with the Al in the materials that the glass was directly deposited on. These data clearly suggest that the Al in the materials does act as a barrier to Na diffusion. The higher the Al concentration in the barrier bait material, the lower the sodium concentration in the fused silica boule at a given depth from the top.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

1. A process for suppressing the migration of monovalent metal ion from a first inorganic material to a second inorganic material at an elevated temperature, comprising forming a barrier layer sandwiched between the surfaces of the first inorganic material and the second inorganic material, said barrier layer comprising aluminum and silica.

2. A process in accordance with claim 1, wherein the monovalent metal ion is selected from alkaline metal ions, Cu⁺, Ag⁺, and combinations thereof.

3. A process in accordance with claim 1, wherein the monovalent metal ions is sodium ion.

4. A process in accordance with claim 1, wherein the barrier layer has a sodium diffusion coefficient at 1000° C. less than 1×10⁻⁸ cm²/s.

5. A process in accordance with claim 1, wherein eth barrier layer has a sodium diffusion coefficient at 1000® C. less than 1×10⁻¹⁰ cm²/s.

6. A process in accordance with claim 1, wherein the material of the barrier layer is formed by using flame hydrolysis process.

7. A process in accordance with claim 6, wherein the material of the barrier layer comprises up to 8% of Al₂O₃ by weight.

8. A process in accordance with claim 6, wherein the barrier layer is directly deposited on the surface of the first inorganic material by using a flame hydrolysis process at an elevated temperature.

9. A process in accordance with claim 6, wherein the barrier layer is a layer of ground particles of Al₂O₃—SiO₂ glass preformed by using a flame hydrolysis process.

10. A process in accordance with claim 9, wherein the ground particles are produced from consolidated glass.

11. A process in accordance with claim 9, wherein the ground particles are produced from porous unconsolidated glass.

12. A process in accordance with claim 6, wherein the barrier layer formed is a continuous vitreous Al₂O₃—SiO₂ glass layer.

13. A process in accordance with claim 1, wherein the barrier layer is formed by depositing a layer batch melted aluminosilicate glass.

14. A process in accordance with claim 13, wherein the aluminosilicate glass comprises Al₂O₃ in the amount of 20-40% by mole.

15. A process in accordance with claim 13, wherein the aluminosilicate glass is a CaO—Al₂O₃—SiO₂ glass, a La₂O₃—Al₂O₃—SiO₂ glass or a mixture thereof.

16. A process in accordance with claim 13, wherein the aluminosilicate glass has a sodium concentration lower than 500 ppb.

17. A process in accordance with claim 1, wherein the barrier layer is formed from a sol-gel.

18. A process in accordance with claim 17, wherein the sol-gel is produced from: at least one hydrolysable silicon compound having the following general formula
Rₘ—Si—Xₙ (I),
where R independently is a non-hydrolysable group, X independently is a hydrolysable group, m is an integer from 0 to 3, inclusive, n is an integer from 1 to 4, inclusive, and m+n=4; and
at least one hydrolysable aluminum compound having the following general formula
Sₒ—Al—Yₚ (II),
where S independently is a non-hydrolysable group, Y independently is a hydrolysable group, o is an integer from 0 to 2, inclusive, p is an integer from 1 to 3, inclusive, and o+p=3.

19. A process in accordance with claim 18, wherein:
R and S independently are selected from the group consisting of optionally fluorinated C₁-C₂₄ alkyl and optionally fluorinated phenyl, X and Y independently are selected from the group consisting of hydrogen, halogen and OR′ where R′ is a C₁-C_{4 alkyl.}

20. A process in accordance with claim 17, wherein the barrier layer is deposited initially in the form of an aqueous sol-gel slurry followed by drying.

21. A process in accordance with claim 17, wherein the barrier layer is initially deposited in the form of dried porous sol-gel material.

22. A process in accordance with claim 17, wherein the barrier layer is initially deposited in the form of consolidated sol-gel material.

23. A process in accordance with claim 17, wherein the barrier layer is formed from: at least one hydrolysable silicon compound having the following general formula
Rₘ—Si—Xₙ (I),
where R independently is a non-hydrolysable group, X independently is a hydrolysable group, m is an integer from 0 to 3, inclusive, n is an integer from 1 to 4, inclusive, and m+n=4; and
alumina particles in an aqueous suspension.

24. A process for forming silica-containing body, comprising the following steps:
(a) providing a substrate having a top surface;
(b) providing a barrier layer comprising alumina and silica that suppresses Na migration at elevated temperature over the top surface of the substrate;
(c) providing soot particles; and
(d) collecting the soot particles on top of the barrier layer to form the silica-containing body at an elevated forming temperature in a furnace.

25. A process in accordance with claim 24, wherein in step (a), the substrate provided has a sodium concentration of at least 500 ppb.

26. A process in accordance with claim 24, wherein in step (b), the barrier layer has a sodium diffusion coefficient at 1000° C. of lower than 10⁻⁸ cm²/s.

27. A process in accordance with claim 24, wherein in step (b), the barrier layer has a sodium diffusion coefficient at 1000° C. of lower than 10⁻¹⁰ cm²/s.

28. A process in accordance with claim 24, wherein in step (c), the soot particles are provided by flame hydrolysis process.

29. A process in accordance with claim 24, wherein in step (c), the temperature is over 1500° C.

30. A process in accordance with claim 24 further comprising, after step (a) and prior to step (b), an additional step (a1):
(a1) providing a bait sand layer on the top surface of the substrate;
whereby in step (b), the barrier layer is formed on top of the bait sand layer.

31. A process in accordance with claim 30, wherein in step (a1), the bait sand layer provided on the top surface of the substrate has a sodium concentration of at least 500 ppb.

32. A process in accordance with claim 24, wherein in step (b), the material of the barrier layer is formed via flame hydrolysis process.

33. A process in accordance with claim 32, wherein in step (b), the material of the barrier layer is formed via flame hydrolysis process in the same furnace where the silica-containing body is formed.

34. A process in accordance with claim 32, wherein the material of the barrier layer comprises Al₂O₃ up to 8% by weight.

35. A process in accordance with claim 32, wherein the barrier layer thus formed is a continuous vitreous Al₂O₃—SiO₂ glass layer.

36. A process in accordance with claim 24, wherein in step (b), the barrier layer is formed by depositing a layer of ground aluminosilicate glass power.

37. A process in accordance with claim 36, wherein the aluminosilicate glass comprises Al₂O₃ in the amount of 20-40% by mole.

38. A process in accordance with claim 36, wherein the aluminosilicate glass comprises sodium less than 500 ppb.

39. A process in accordance with claim 36, wherein the aluminosilicate glass is selected from CaO—Al₂O₃—SiO₂ glasses, La₂O₃—Al₂O₃—SiO₂ glasses and mixtures thereof.

40. A process in accordance with claim 24, wherein in step (b), the barrier layer is formed from a sol-gel.

41. A process in accordance with claim 40, wherein the sol-gel is produced from:
at least one hydrolysable silicon compound having the following general formula
Rₘ—Si—Xₙ (I),
where R independently is a non-hydrolysable group, X independently is a hydrolysable group, m is an integer from 0 to 3, inclusive, n is an integer from 1 to 4, inclusive, and m+n=4; and
at least one hydrolysable aluminum compound having the following general formula
Sₒ—Al—Yₚ (II),
where S independently is a non-hydrolysable group, Y independently is a hydrolysable group, o is an integer from 0 to 2, inclusive, p is an integer from 1 to 3, inclusive, and o+p=3.

42. A process in accordance with claim 41, wherein:
R and S independently are selected from the group consisting of optionally fluorinated C₁-C₂₄ alkyl and optionally fluorinated phenyl, and X and Y independently are selected from the group consisting of hydrogen, halogen and OR′ where R′ is a C₁-C₄ alkyl.

43. A process in accordance with claim 40, wherein the barrier layer is deposited initially in the form of an aqueous sol-gel slurry followed by drying.

44. A process in accordance with claim 40, wherein the barrier layer is initially deposited in the form of dried porous sol-gel material.

45. A process in accordance with claim 40, wherein the barrier layer is initially deposited in the form of consolidated sol-gel material.

46. A process in accordance with claim 40, wherein the barrier layer is formed from:
at least one hydrolysable silicon compound having the following general formula
Rₘ—Si—Xₙ (I),
where R independently is a non-hydrolysable group, X independently is a hydrolysable group, m is an integer from 0 to 3, inclusive, n is an integer from 1 to 4, inclusive, and m+n=4; and
alumina particles in an aqueous suspension.

47. A process in accordance with claim 24, wherein the silicon-containing body is formed in a direct-deposit flame hydrolysis furnace, and the substrate provided in step (a) is the bottom of the rotating cup for collecting the soot and forming the body therein.

48. A process in accordance with claim 24, wherein the silicon-containing body formed has a Na concentration less than 20 ppb in the area abutting the barrier layer.

49. A process in accordance with claim 24, wherein the silicon-containing body formed has a Na concentration less than 10 ppb in the area abutting the barrier layer.

50. A process in accordance with claim 24, wherein in step (b), the barrier layer, when dried and subjected to a temperature over 1200° C., has a thickness less than 2 cm.

51. An barrier material comprising silica and alumina for suppressing the migration of monovalent metal ion between inorganic materials at an elevated temperature, wherein the amount of alumina in the barrier material is between 3% and 90% by weight of the total amount of alumina and silica, and the barrier material has a sodium diffusion coefficient at 1000° C. of less than 1×10⁻⁸ cm²/s.

52. A barrier material in accordance with claim 51, wherein the amount of alumina is between 20% and 60% by weight of the total amount of alumina and silica.

53. A barrier material in accordance with claim 51 consisting essentially of alumina and silica.

54. A barrier material in accordance with claim 51 having a sodium diffusion coefficient at 1000° C. of less than 1×10⁻¹⁰ cm²/s.

55. A barrier material in accordance with claim 51 having monovalent metal ion concentration of less than 50 ppm.

56. A barrier material in accordance with claim 51 having a sodium metal ion concentration of less than 50 ppm.

57. A barrier material in accordance with claim 51 having a sodium metal ion concentration of less than 20 ppm.

58. A barrier material in accordance with claim 51 having a sodium metal ion concentration of less than 5 ppm.

59. A barrier material in accordance with claim 51 having a sodium metal ion concentration of less than 500 ppb.

60. A barrier material in accordance with claim 51, wherein the silica and alumina distribute substantially evenly in the material.

61. A barrier material in accordance with claim 51, which forms a continuous layer when subjected to the elevated temperature at which the material is used.

62. A barrier material in accordance with claim 51 which forms a continuous layer at a temperature about 1500° C.
